(19) United States
(12) Patent Application Publication
(10) Pub. No.: US 2015/0012342 A1
(43) Pub. Date: Jan. 8, 2015

(54) METHOD AND SYSTEM FOR INTERNET-BASED SOCIAL-NETWORKING APPLICATION FOR FACE-TO-FACE VENUES

(71) Applicant: Abtin ROSTAMIAN, Pasadena, CA (US)

(72) Inventor: Abtin ROSTAMIAN, Pasadena, CA (US)

(21) Appl. No.: 13/935,441

(22) Filed: Jul. 3, 2013

(51) Int. Cl. G06Q 30/02; G06Q 50/00

(52) U.S. Cl. CPC G06Q 30/0252; G06Q 50/01
USPC 705/14.5

(57) ABSTRACT

In one example embodiment, a method includes the step of obtaining a member profile of a user for an event service. A step includes aggregating the member entity profile into a set of member profiles. A step includes summarizing the set of member profiles into an attendee list, wherein the attendee list is viewable event via an online event service webpage. A step includes enabling the user to flag another attendee of the attendee list with a client-side application of a mobile device. A step includes tracking the user at an event related to the attendee list. A step includes determining when the user interacted with the other attendee. A step includes receiving digital notes from the user about the other attendee. A step includes suggesting third member entities for the user to flag based on historical user flagging behavior or user profile information.

### CROSS-REFERENCE TO RELATED APPLICATIONS

This application claims the benefit of U.S. Provisional Application No. 61/667,425, filed Jul. 3, 2013 and titled ‘A METHOD AND SYSTEM FOR INTERNET-BASED SOCIAL-NETWORKING APPLICATION FOR FACE-TO-FACE VENUES SUCH AS EVENTS, MEET-UPS, CONFERENCES, TRADE-SHOWS AND THE LIKE’. This provisional application is incorporated herein by reference.

### BACKGROUND

Events (e.g. conferences, continuing education and/or professional development meetings, seminars, group meet ups, networking events, and the like) can involve a plurality of different parties. Each participating member entity (e.g. hosts, attendees, partners, and sponsors/advertisers) may have certain goals to accomplish at a given event.

These goals may involve ascertaining attributes (e.g. demographic analytics) and statistical information (e.g. event tracking analytics) about various other member entities. An attendee may wish to meet other attendees with certain attributes. For example, a potential sponsor may want to sponsor events organized by organizers with certain historical statistical metrics and/or attributes. An organizer may want to obtain metrics on the interactions of member entities attending and/or participating in their events to ascertain certain information such as the average attendance time, number of interactions, and success rate of premeditated interactions (interactions that were desired ahead of time) between member entities, et al. At the same, such statistics about various member entities may not be available and/or may be limited. Obtaining this information may involve tracking party behavior at a granular enough level to aggregate the data necessary to provide desired statistics. However, current systems of event planning and administration may not include the tools to provide sufficient statistical data to aid parties with event-related decisions.

Furthermore, a member entity may want historical and analytical data about its own event activities. For example, an attendee may want to access his own event-tracking data to determine if he met certain other attendees and/or to determine if he accomplished his goals regarding the event. Thus, a method and system are desired for using an Internet-based social networking application to track event member entities and generate analytical information accordingly.

### BRIEF SUMMARY OF THE INVENTION

In one aspect, a method includes the step of obtaining a member profile of a user for an event service. A step includes aggregating the member entity profile into a set of member profiles. A step includes summarizing the set of member profiles into an attendee list, wherein the attendee list is viewable event via an online event service webpage. A step includes enabling the user to flag another attendee of the attendee list with a client-side application of a mobile device. A step includes tracking the user at an event related to the attendee list. A step includes determining when the user interacted with the other attendee. A step includes receiving digital notes from the user about the other attendee. A step includes suggesting third member entities for the user to flag based on historical user flagging behavior or user profile information.

### BRIEF DESCRIPTION OF THE DRAWINGS

The present application can be best understood by reference to the following description taken in conjunction with the accompanying figures, in which like parts may be referred to by like numerals.

FIG. 1 is a block diagram of a sample computing environment that can be utilized to implement some embodiments.

FIG. 2 depicts an exemplary computing system that can be configured to perform any one of the processes provided herein.

FIG. 3 illustrates an exemplary online event system architecture, according to some embodiments.

FIGS. 4 A-B illustrate an example process for internet-based social-networking application for face-to-face venues, according to some embodiments.

The Figures described above are a representative set, and are not an exhaustive with respect to embodying the invention.

### DETAILED DESCRIPTION

Disclosed are a system, method, and article of manufacture of internet-based social-networking application for face-to-face venues. Although the present embodiments have been described with reference to specific example embodiments, it can be evident that various modifications and changes may be made to these embodiments without departing from the broader spirit and scope of the particular example embodiment.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, attendee selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Example EMBODIMENT

The embodiments include an internet-based technologies comprising of a server with a data store for the backend, a customer facing website and/or mobile versions of the application on mobile devices (e.g. see mobile devices 402 A-C infra) such as smartphones (e.g. iPhone®, Blackberry®), tablet computers (e.g. iPad®), e-book readers, laptop computers, other ‘smart’ attendee appliances (e.g. a smartpen that can communicate with a computer network) and the like.

Member entities can create one or more profiles on an online event service (e.g. user event server 408). The profile(s) can be associated with a particular venue/event that the attendee is attending and/or participating in. Other member entities can access the online event service and view profiles of other attendees associated with the venue/event. The online event service can be accessible by an interface (e.g. a web browser and/or other native application) operating on a desktop computer or in a mobile device e.g., using a mobile version of the site or a native application. In some embodiments, a member entity can associate only one of profiles to a particular venue/event.

A member profile can create multiple profiles corresponding to multiple venues such that they can portray different information in their profile depending on the venue. For example, if an attendee is attending a business mixer for a startup venture, the attendee can associate a different profile with that event then when the attendee attends a canyoneering venue.

Attendee profiles (it is noted that other member entity profiles can be created and managed in a similar manner) can include such elements as a picture of the attendee, contact information, relevant background information (such as a bio of the attendee or information about the attendee's company), what the attendee is searching for at the venue (e.g., investors for a startup, a canyoneering expert for an upcoming rock climbing trip, etc.), what the attendee is offering, and the like. For example, an attendee profile can include that the attendee is an investment advisor and is offering free one hour consultation to members at the venue or something similar. Profiles can also include testimonials/personal references to give the attendee more credibility. These references can be links to other members of the online event service that can vouch for the attendee, or external references (e.g. can include contact information such as contact information of a previous employer, and the like). It should be noted that testimonials/personal references may be reviews by other attendees based on interactions with the provided attendee at a venue, or it could be just a testimonial by another attendee who personally knows the provided attendee. The profile can further include an uploadable content area where the attendee can upload relevant content such as pictures, documents (e.g. business plans, business cards, resumes, executive summaries, awards, etc.).

Member entity profiles can be aggregated and summarized in an attendee list which can be viewable by all member entities of the venue/event via the online event service. In this list, member entities can flag other attendees that they would like to meet at the event. This information can be shared via the online event service available. For example, a member entity's profile for an event can be provided to other member entities that were flagged by a member entity. After flagging the other member entities, the online event service can create a separate ‘like-to-meet’ list of the member entities that a given member entity has indicated that he/she would like to meet at the venue.

The online event service can keep track of which member entities actually met the people in the flagged list. For example, each member entity's mobile device can include a client application/instance of the online event service. The client application can include a proximity detection system where the application automatically determines and indicates that the attendee came into contact with a flagged attendee. In another example, the client application can be configured to enable an attendee to manually indicate that one or more flagged attendees have been met. Again, this information can be stored by the online event service and/or shared with other attendees, event organizers (e.g. hosts), and/or event sponsors.

The online event service can enable the member entities to write notes about the other member entities. The notes can be stored in a separate area for private viewing by the author. For example, the notes can be written on the mobile device while at the event and/or later on the website when the attendees are at home.

Upon adding a member entity to a list, the online event service may notify the other member entity that they were added to someone's list. For example, attendee Joe browses the list of attendees, views Bob's profile from the list, includes Bob to his like-to-meet list, the online event service can notify Bob that he was added to Joe's list. Additionally, the online event service can notify event organizers and/or event sponsors and/or provide summarized metrics of this activity. The online event service may also notify a member entity if/when people on their list (e.g. a like-to-meet list) arrive at the event. For example, the client application can push attendee's mobile device location information to an online event service server that then tracks the location of the attendees for the period associated with the event. Location can be matched with venue location. In this way, the online event service can determine whether an attendee is currently at the event and provide notifications accordingly.

The online event service may also suggest other member entities for the member entity to add to his/her like-to-meet short list based on what the member entity has indicated that he/she is searching for in the profile and also based on the types of members that the member entity has previously added to the ‘like-to-meet’ list. For example, the online event service server can compare profile information between attendees and determine matches based on specified criteria (e.g. match a startup entrepreneur with an investor interested in similar technology, and the like). In another example, an attendee may be matched with a representative of a sponsor/advertiser of the event that the system has determined would be a beneficial match (e.g. match a chief technology officer of a company with a representative of a server hosting company who is sponsoring the event). This suggestion may also be influenced by reviews the member entity wrote about other member entities or influenced by adaptive heuristics that “learn” what the user is looking for based on behavioral patterns such as browsing behavior. It is noted that online event service communications can be performed according to various communication protocols such as SMS messaging, email, messages to a user's profile messages, microblog posts, etc. Online event service suggestions can include various information about a suggested member entity such as brief background, profile image(s), current location and the like.

The online event service can also enable member entities to flag other member entities already met for a follow-up contact. Upon doing so, said member entities can be included into a follow up list that stored by the online event service server. The online event service can later communicate follow up reminders. The online event service can also enable member entities to create custom lists other than the ‘like-to-meet’ list. For example, an attendee can create an event/venue specific list especially for another attendee type such as an investor list for event X, or a peer list for venue Y, etc.

Member entities such as attendees may use the client application of the online event service to check into venue upon arriving and check out via leaving. This check in/check out process may be done either automatically by the system automatically detecting changes in the attendee's location based on a location service such Global Positioning System (GPS/AGPS) and/or by direct mobile-to-mobile proximity detection using communication protocols such as Bluetooth or WiFi or Near Field Communication (NFC). In other examples, the attendee can manually indicate the check in or check out process utilizing the client application in the attendee's mobile device. As noted, client applications can be developed for specific types of mobile devices such that the displays provided by the client application are fitted to the display of the particular mobile device and the like. By checking in, the online event service can also enable member entities such as attendees to automatically message the host/organizer of their presence, let people who have added the attendee to their ‘like-to-meet’ list know that the attendee have arrive and/or left, start collecting analytics on the attendee's interactions or behavior at the event. If external ticketing systems such as Eventbrite.com®, Ticketmaster®, Meetup.com® were used for the venue, the online event service can automatically communicate with those external systems and mark the member entity as arrived where it is applicable.

Member entities may use the client application (e.g. a mobile version) while at the venue to unidirectionally or bidirectionally interact with activities at the venue. Examples of said interaction can include: attendees submitting questions to a question and answer session, participation in voting events at the venue. For instance, the host asks where the next venue should be and pushes that vote to all of the attendee's application instances. The attendees can then respond to the vote on their mobile device. Other examples of said interaction can include: feedback to the host, subscribe to future venues, subscribe to future venues by the same host/organizer, raffle/contest entries and notifications of whether or not the attendee won, etc. If a raffle/contest requires payment for entry, the payment can be made directly on the mobile device. Attendees can use the application to make donations, payment for entry, or payment to the host/organizer for extra value services offered at the venue directly on the mobile instance of the application. Attendees can receive notifications before, after, or during the venue from the host, organizers, sponsors, advertisers, and/or attendees. For example, this can be done using an instant-message format, a ‘Push’ like notification as found in the iPhone® and Android® operating systems, via an email-like message format, and the like.

The online event system may also suggest other venues by different hosts/organizers based on analytics information collected from the attendee or by inferring the interest of the attendee based on the events that he/she has attended (or even just browsed online) thus far. The suggestions can also be achieved by seeing what other venues other attendees of the same venue that the attendee also attended are going to. The suggestions can also be made based on the reviews the attendee wrote for venues he/she already attended. Other suggestions, such as suggesting a sponsor/advertiser or partner (SAPs) to a host/organizer (and vice-versa), can also be made by the online event system.

The online event system can further provide a point earning mechanism. For example, the attendee can earn points for attending venues and/or participating in activities within the venue that can be used in the future for some reward/retention purpose.

The online event system can enable information exchange of member entities in other ways (e.g. additional information that would like to be exchanged between attendees that aren't already present in the public profile of the attendees). An example may include: attendees can either manually send each other additional information by selecting one another's names from the attendee list or automatically done by application based on proximity. For example, the client application can detect the attendees are within a specific area of the event and provide a list that enables the attendees to select other attendees to whom they can send the information.

The online event system can also implement electronic ticketing operations. The client application can retrieve an attendee's admission ticket from the built-in ticket service or from external ticketing agencies (e.g. via API calls). The online event system can enable an attendee to sell/transfer his ticket to another attendee. In one example, if an attendee is attending the venue without a ticket the system may provide the following options: the ability to purchase a ticket on the spot, the ability to purchase/transfer a ticket from someone on the attendee list (or even the host/organizer) who has indicated that he/she can't make the event, the ability to be on a standby list at the event and be able to be notified if they receive permission to attend and/or receive notification that someone is willing to transfer/sell their ticket to them.

The online event system can also implement report generation operations. Member entities can be enabled to generate reports of their interactions at the event in a convenient and easy to read format to aid them in the follow up process.

The online event system can also implement social sharing operations. The online event system enable member entities to notify others, even outside of the online event system (e.g. by automated email, microblog posts, etc.) about the event via social channels such as Facebook®, Twitter®, and the like. Member entities can utilize the client application to post updates during the event about their interactions on their social channels. The online event system can also implement review operations. In one example, attendees can write reviews of each other and the event/venue. The reviews can be stored by the online event system server.

The online event system can also enable hosts (e.g. can include organizations/individuals/corporations that organize the event) to create a profile. The profile can describe various information about the host and the types of events/venues they organize. The online event system can provide this information to prospective attendees and sponsors/advertisers/partners. The profile can include the following: image and/or logo of the host/organization, contact/venue location information, reviews by other members (e.g. past attendees) and sponsors/advertisers/partners, biographical information of key players of the host organization (and/or information about the host/organization itself), venue schedules, types of sponsors/advertisers/partners that the host wishes to work with, target audience type(s), average attendee counts of past events, user uploadable data (external links, flyers, images of past events), etc. The online event system can provide analytics information about host/organizers and their respective venues. The analytics may include, inter alia, the following information: list of attendees along with their respective profiles, attendance rate(s), the differentials between the number of people signed up versus actually attended, a list of those that didn't attend (as well as such information as to the number of attendees that transferred their ticket to someone else or to someone on the wait list), period of stay for each attendee stayed on an individual and/or collective basis (e.g. an average of all attendees), the number of interactions attendees had on an individual and/or collective basis, various attendee loyalty metrics such as number of attendees as repeat customers, the number of attendees referred by other attendees, the number of attendees who attended the venue based on a referral, etc. The analytics may include other information as well, for example: attendee sources such as how the attendees heard about the venue; what entity was the top referrer of attendees, insight into the attendee's list (such as the like-to-meet lists). Additional information can be obtained and provides such as a list of most popular attendees, reviews of attendees on said lists, number of successful connections, and the like. For example, the online event system can determine the rate of successful connections that attendees indicated they would like to have (e.g. on their like-to-meet). Thus, the online event system can look at each attendee's list, and determine out how many of the people on that list the attendee successfully met. It then can provide analytics both on an individual and on an aggregate level. Another metric that can be used by the online event service can include the commonalities of the attendees being added to lists. For instance, the host can determine that the types of people being added to a like-to-meet list tend to be investors or venture capitalists. Further data can be extrapolated by seeing the types of people that are doing the adding. For example, the host can see early stage entrepreneurs tend to mostly add angle investors to their like-to-meet list. It is noted that the like-to-meet list is just a specific example of a list; other list types may exist and would provide different types of extrapolations. The online event service can enable member entities to view personal information such as, inter alia, profession, age, location (in terms of where the attendees live or operate out of), gender, race on both an individual and/or collective basis, etc. The online event service can enable member entities to view the results of votes, raffles, activity participation both on an individual and collective basis, etc. The online event service can enable potential attendees to view sponsor/partners/advertisers interest data, the number of attendees interacted with sponsors, and the number of attendees that found sponsors/partners/advertisers of use. The online event service can enable member entities to view various feedback analytics such as from sponsors/partners/advertisers (e.g. what did they think of the attendees, did they generate any leads and if so, what was the conversion rate, would they participate in the venue again. The online event service can enable member entities to view various feedback analytics such as from attendees (e.g. did they find the venue useful, would they attend again, would they refer the venue to others). The online event service can provide revenue analysis of past events/venues (e.g. how much was collected from ticket sales, advertisers, and/or expenditures). Broadcast messaging analytics can be provided to a host if such messages are sent. As used herein, a broadcast message can include a message sent to a plurality of users determined by certain filter information (e.g. profession, analytic data and/or other attributes). The data can include information about the open/read rate of the messages by the targeted audience. The online event service can provide information about member entity interactions.

Activities of a pre-defined or custom type may be created such as an ad-hoc question and answer (Q&A) session with the panel, a raffle, a contest, etc. For instance, the host can decide to have a Q&A session in fifteen (15) minutes. They can provide the notifications (e.g. push notifications) to the mobile devices of present attendees. The activities may include bi-directional interaction. In the case of a Q&A session, attendees can use the client application to submit questions to the host (via the online event service server(s)). In the case of a contest, the host may pose multiple-choice questions to which the attendees can respond. In the case of a raffle, the host may ask whether the attendee would like to participate. The attendee can use the client application in his mobile device to opt-in. This may even involve a payment to enter which the app may handle as well either internally or by calling an external payment process such as PayPal®. The online event service can provide a means to broadcast messages to relevant entities such as attendees. Instead of announcing something over the loudspeaker or writing something on the bulletin-board such as schedules, notices, calls to attention, etc., the host can achieve this by electronically sending a broadcast message to the attendee's mobile devices (e.g. a text message, a push notification that the client application displays with the mobile device).

The online event service can provide a means for direct messaging (bidirectional or unidirectional) relevant member entities such as attendees. For example, the host may choose to directly communicate with specific people during, before, or after the event. The communication can be one-to-one or one-to-many and the host has the ability to group people into specific groups and contact them with a specific message. For example, the online event service can provide a list of the attendees that are investors and send a group message to the members of that list. The host can also send a specific message to a specific person. The host can receive messages from one or more members. The host can create mailing lists based on specific filters gained from either the attendee's profile information and/or analytics. The host can create direct promotions and offers either from him/her or from the venue's sponsors/partners/advertisers dynamically (or pre-defined) for all attendees, or specific attendees based on filter criteria.

The online event service can provide multi-region venue interoperability. Certain hosts/organizers hold venues which may be multi-regional. For example, the venue can be part of a greater organization that also holds venues in different geographic locations. In such cases the online event service can provide the ability to create a link to affiliated venues. Thus, attendees/sponsors/partners/advertisers across all linked venues can cross communicate, share resources, analytics, messaging, etc. For instance, an attendee of the venue in California can communicate with another member of an affiliated venue in Oregon as if they were at the same venue. The hosts/organizers can create rules for restricting inter-location functionality. For example, the California hosts may create a rule that other linked venues can see the attendee list, but cannot directly message one another. Another example can be where a sponsor/partner/advertiser that is being promoted or is offering some promotion can only be made available to a specific location of the venue. In the event that linked venues are simultaneously holding an event, the hosts/organizers may choose to operate the locations as if they were in one location. This means that they can send a broadcast message and everyone who is currently attending in the Oregon and California locations can get the message at once.

The online event service can further provide operations and functionalities for ticketing management. The application may provide the host/organizer with the ability to create and issue tickets using an internal ticketing system. Alternatively, the application may interface with external ticketing providers and allow the management of those tickets within the external ticketing system. The system may support the use of multiple ticketing systems at once. For instance, the host may choose to use both Eventbrite.com® and Meetup.com® to issue tickets and the online event service can enable interoperability with both system to allow both of those external sources to be managed on one screen within a client-side application window. Likewise the system can push out the appropriate notifications to those systems depending on which systems a provided attendee used.

The online event service can enable survey creation operations and functionalities. The online event service can provide dynamic or predefined creation of survey(s) to be pushed out to the client applications of attendees, partners, advertisers and the like. The online event service can allow the host to create multiple types of survey targeted to specific types/groups of people/organizations. For example a survey can be created for entrepreneurs and a separate survey can be created for investors who attended the venue. The system can send out the appropriate survey to the appropriate attendee of the event.

Member data can be exported by hosts/organizers (and/or be made available via an API call) so that such data can be used on an external system managed by the hosts/organizers. It is noted that in the multi-region scenario, this data may be aggregated across all branches.

The online event service can also permit the ability of the venue (and likewise the host or organization that heads it) to be exposed to external advertisers/partners/sponsors. For example, a host may post information about itself on the dashboards of appropriate sponsors/advertisers/partners (SAPs) searching for venues to promote their goods and services to. Thus, the online event service can provide a ‘matchmaking service’ for the venue organizers/hosts and advertisers/sponsors/partners. The online event service may provide the mechanism for hosts/organizers to acquire attendees from host/organizers of other venues or (directly from the master list of attendees from the online event system) based on specific criteria and/or a proprietary matching process. In one version of the matchmaking service, the SAP can algorithmically browse a lists of hosts/organization and/or venues. The SAP can algorithmically read the various profiles, and then indicate that they would like to partner up with them. The online event system can make suggestions to the advertiser based on information they provided with regards to the types of venues they're looking for. Likewise this process can be reversed to be from the venue perspective. For example, the hosts/organizations can push their venues to potential SAPs with certain attributes.

Another matchmaking service can include a mechanism that identifies the target audience that the host/organizer is searching for based on their existing attendee list or based on the profile that the host/organizer has set up. Based on the analytics and attendee behavior data in the online event service database, a list of prospective attendees can be provided to the host/organizer so that the venue can be promoted to them as well. Alternatively, the host/organizer can create specific filters for attendees. The filters can be set for the various attendee attributes (either directly provided by the attendees or ascertained through the gathering of analytics) that host is seeking to acquire (such as profession, location) and the online event service can provide can return a set of results back. The host can then contact these attendees with promotions and/or advertisements.

The online event service can also provide services to a SAP. A SAP can publish their offerings to potential venue entities. The SAP can create a profile which may include images/logos of the entity, contact information, biographical information (e.g. what they are about, info about the company), reviews (e.g. by attendees, venues, hosts,), desired types of venue, desired types of audiences, a list of what the SAP can offer to a venue (money, resources, and the like). Where applicable, an SAP's profile can also include offers to the venue's attendees, various timeframes of when the SAP would like to sponsor a venue, various user uploadable areas (other materials that they find appropriate to upload).

The online event service can also provide various SAP-related analytics about past venues/events. Analytics can include such information as the number of attendees interacted with a representative of their company (again can be done by proximity detection or by agents/representatives of the SAPs manually indicating who they interacted with), the period each agent/representative spent with an attendee, the number of attendees that showed interest in the product, a measure of organic interest from attendees to the SAP (e.g. the number of attendees on their own who inquired about the SAP's offering), the acquisition cost (e.g. how much advertising money was spent and how much in business/interest was received), attendee demographics (e.g. age, profession, location, gender, income). If broadcast messages are sent, the online event service can keep track of the number of those messages that were opened. Part of being a SAP may mean that the host/organizer allows the SAPs to send a certain number of broadcast messages (e.g. via email, push notification, text message, and the like) during the event.

The message can be sent to the mobile devices of the attendees to promote the SAPs goods, services, or even just brand recognition. The SAPs can have the ability to send messages based on specific filters such as data found in the attendees profiles and/or even data from analytics (or a combination of both). For instance, an SAP can make a specific offer to all of the investors in the crowd, and a separate offer to all of the entrepreneurs. The online event system can determine the message's target members based on the filter's parameters and send out the appropriate message to the targeted members.

SAPs can also create offerings dynamically or in a predefined manner for attendees. For example, at the event, the SAP may decide to give everyone a 20% discount on their product, or offer one hour of free consultation. This offering can be created and the attendees may be notified on the spot via their mobile devices (using the broadcasting messaging feature notified above or as part of an aggregate update message from the host/organizer of all SAPs offerings during, before, or after the event). In the event that the SAPs are participating in a multiregional venue, they can have the ability to participate in one or more of the locations. The SAPs can also have the ability to create separate and distinctive offerings for different locations. They may, for example, give twenty percent (20%) off to the California branch and twenty-five percent (25%) off to the Oregon branch. The aforementioned analytics data may also be harvested on a single or multiregional basis as well.

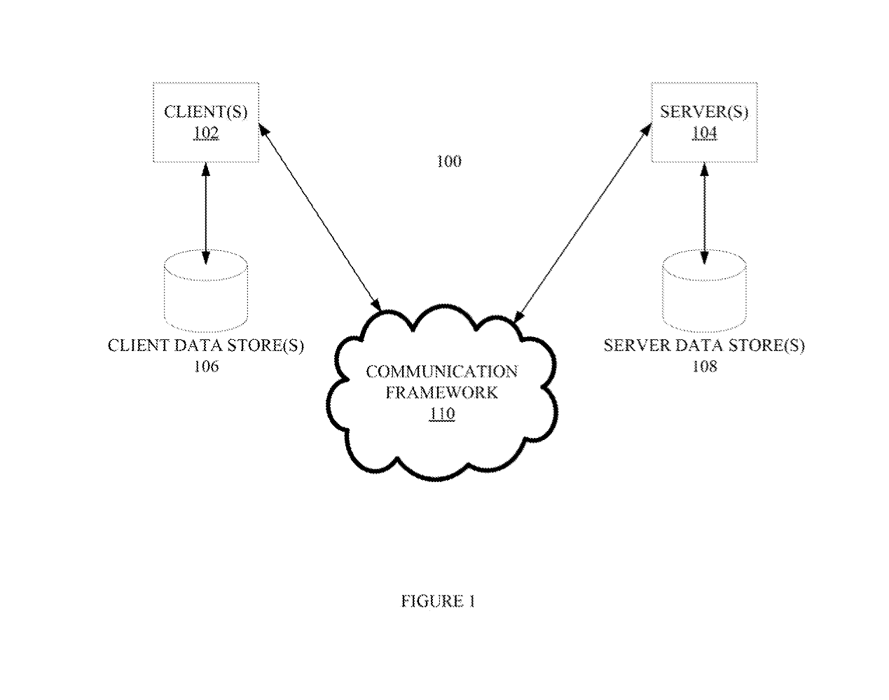

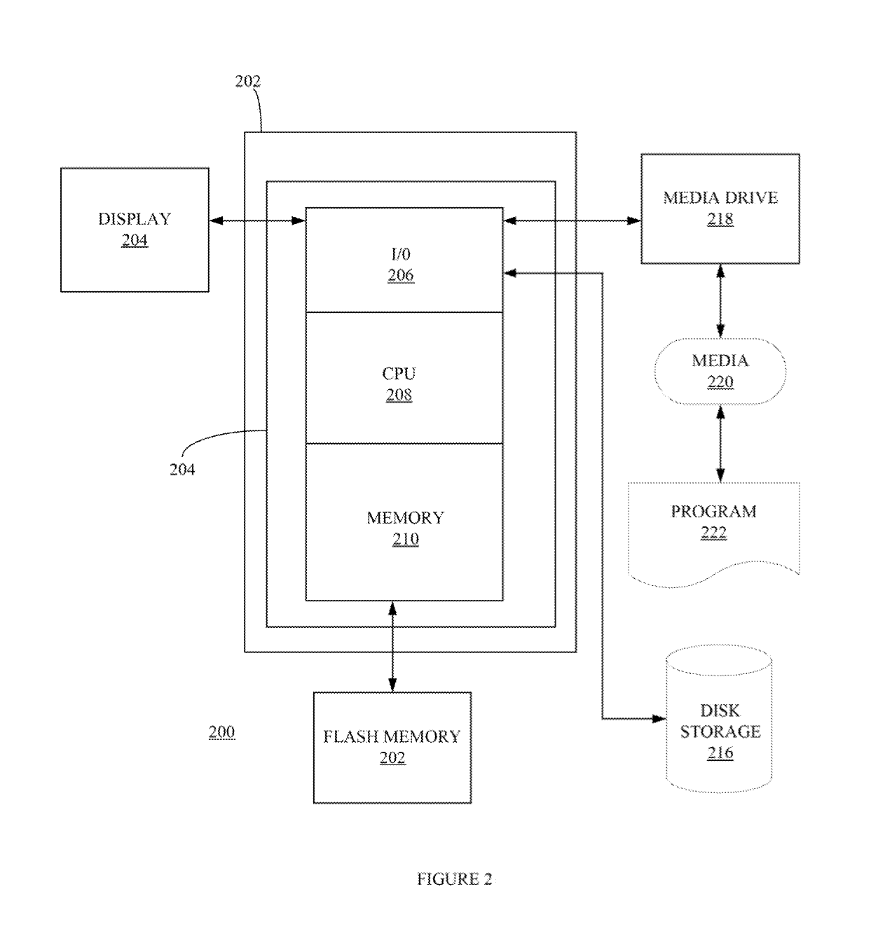

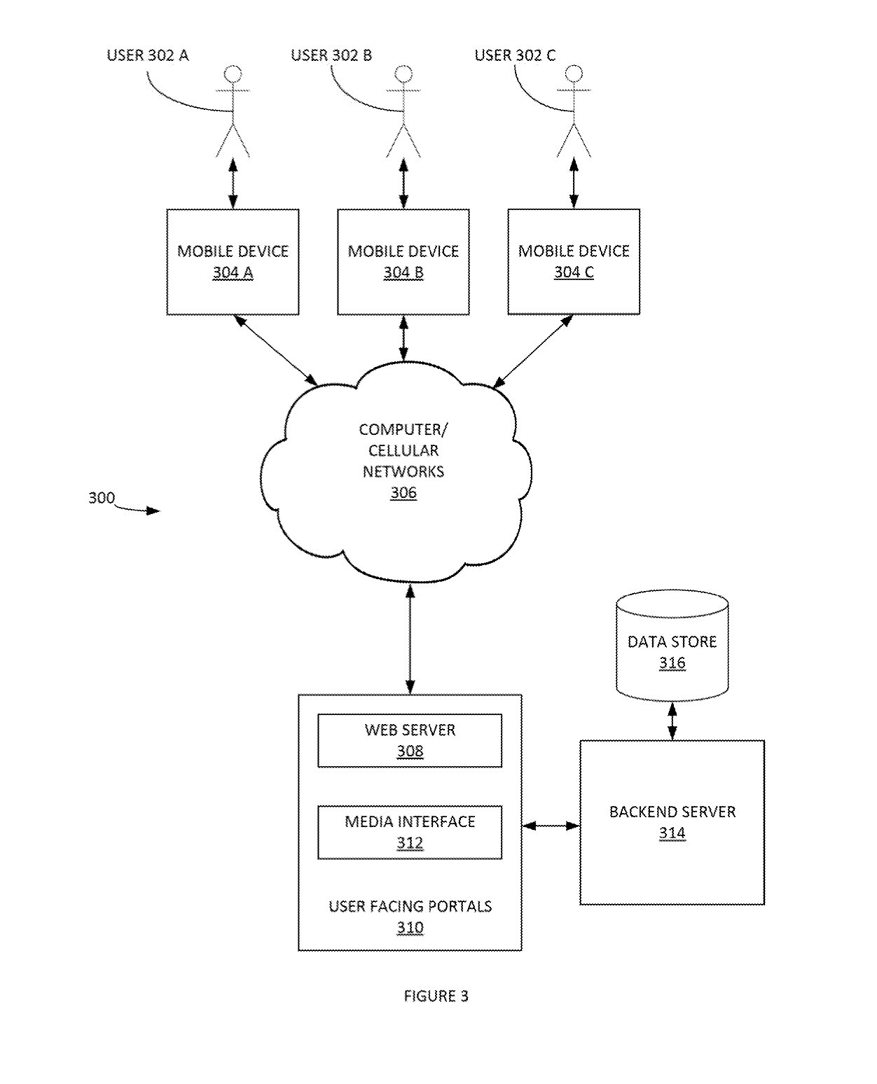

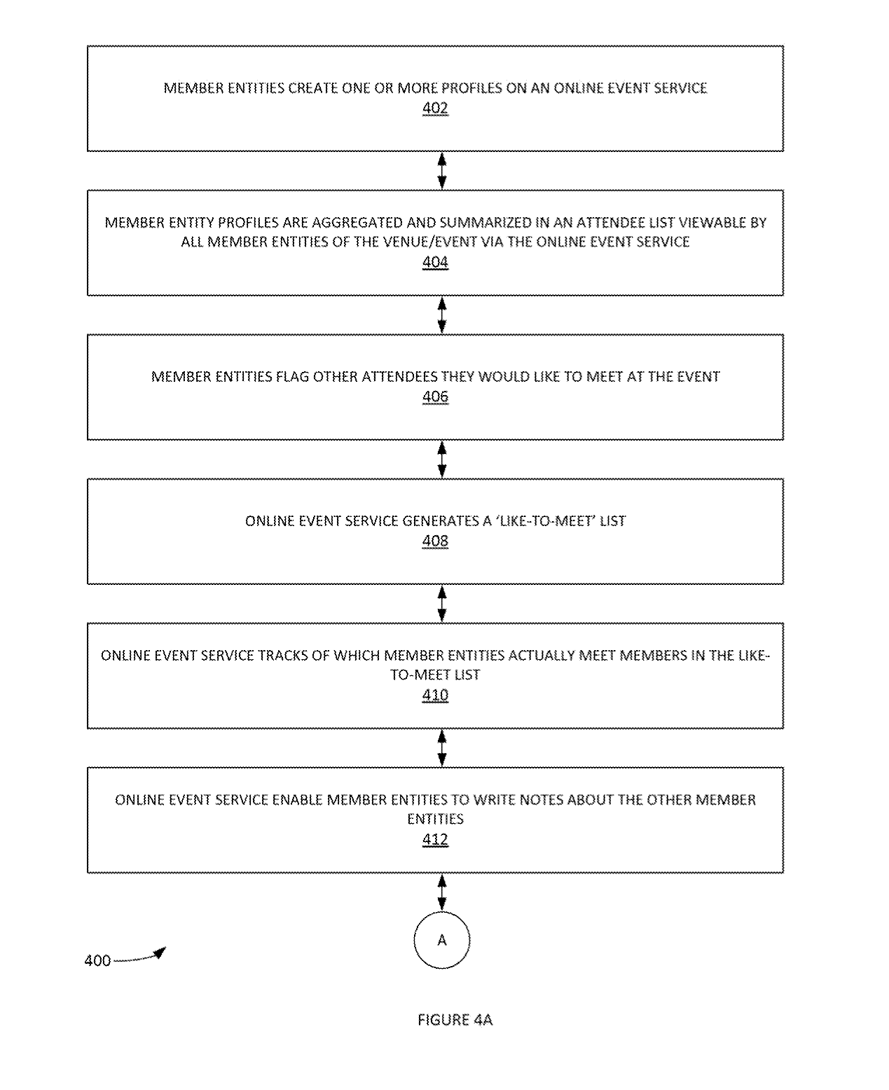

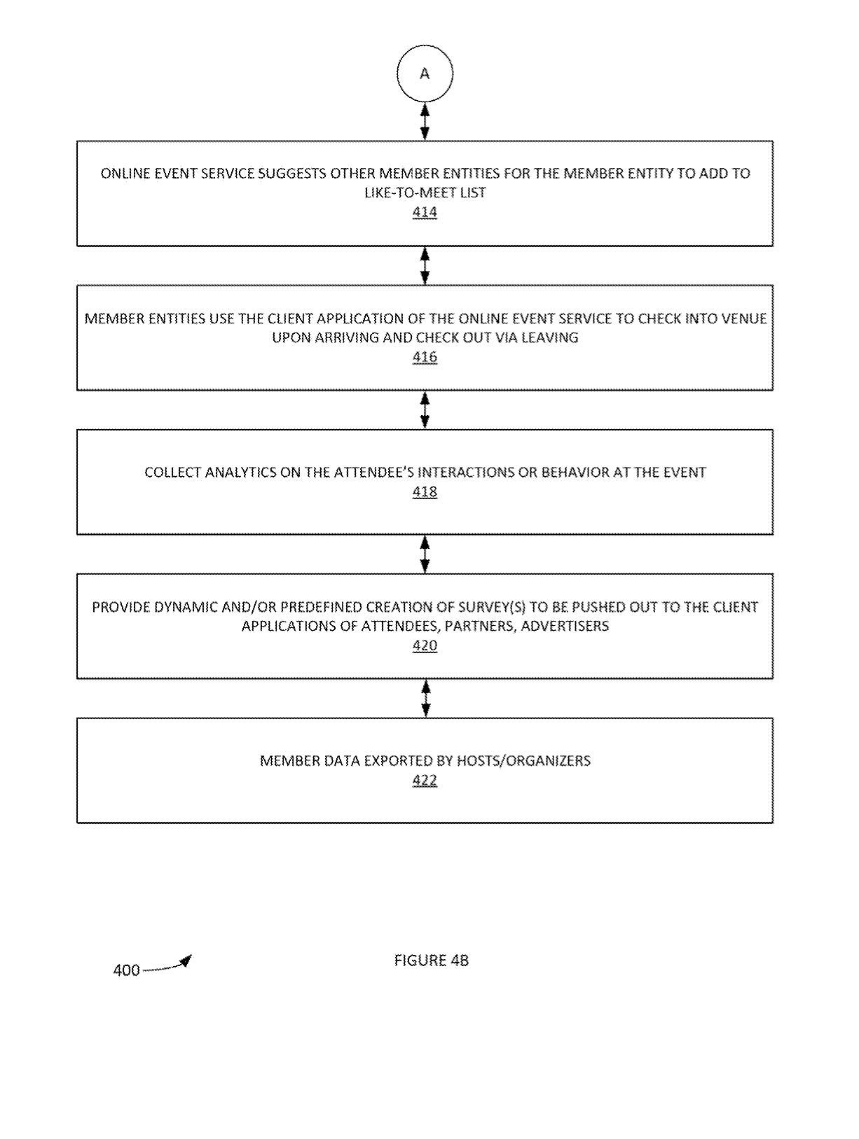

Broadcast messages may also be sent to all linked venues at once. For example, the host/organizer may choose to restrict this functionality as part of the rules it sets for its linked venues. The systems and figures of FIG. 1, FIG. 2, FIG. 3, FIG. 4 can be utilized to implement the above described online event system and its functionalities.

### Environment and Architecture

FIG. 1 is a block diagram of a sample computing environment 100 that can be utilized to implement some embodiments. The system 100 further illustrates a system that includes one or more client(s) 102. The client(s) 102 can be hardware and/or software (e.g., threads, processes, computing devices). The system 100 also includes one or more server(s) 104. The server(s) 104 can also be hardware and/or software (e.g., threads, processes, computing devices). One possible communication between a client 102 and a server 104 may be in the form of a data packet adapted to be transmitted between two or more computer processes. The system 100 includes a communication framework 110 that can be employed to facilitate communications between the client(s) 102 and the server(s) 104. The client(s) 102 are connected to one or more client data store(s) 106 that can be employed to store information local to the client(s) 102. Similarly, the server(s) 104 are connected to one or more server data store(s) 108 that can be employed to store information accessible by the server(s) 104. In some embodiments, system 100 can be included and/or be utilized by the various systems and/or methods described herein. System 100 can be implemented in cloud computing environment.

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 202 related to it. The I/O section 206 can be connected to a display 204, a keyboard and/or other attendee input (not shown), a disk storage unit 216, and a media drive unit 218. The media drive unit 218 can read/write a computer-readable medium 220, which can include programs 222 and/or data. Computing system 200 can include a web browser. Moreover, it is noted that computing system 200 can be configured to include additional systems in order to fulfill various functionalities. Display 204 can include a touch-screen system and/or sensors for obtaining contact-patch attributes from a touch event. In some embodiments, system 200 can be included and/or be utilized by the various systems and/or methods described herein.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++, Java, and/or Python) and/or some specialized application-specific language (PHP, Java Script, XML).

FIG. 3 illustrates an exemplary online event system 300 architecture, according to some embodiments. Online event system 300 can include the user facing portals 310, the backend server 314 (e.g. an event server) and the datastore 316. The user facing portals 310 can operate as a client-side application in users' 302 A-C computing devices (e.g. mobile device 304 A-C). For example, user facing portal 310 can be implemented in website accessed by a mobile device such as mobile devices 304 A-C. Accordingly, user facing portal 310 can include a web server 308 and/or another media interface 312. In another example, a user facing portal can be implemented in mobile device mobile devices 304 A-C as a native application. The exemplary online event system architecture can include modules (not shown) that implement the various functions described supra. For example, a list module can enable member entities to generate lists. Various algorithms can then determine if a member of a list set is completed. For example, an attendee can generate a list of other attendees to meet. The list can include actual other attendees and/or identity other attendees by a specified attribute (e.g. other attendees who self-identify as an investor, other attendees who self-identify as a patent attorney, etc.). The exemplary online event system can utilize various sensors and applications of a member entity's mobile device to automatically determine if the attendee that generated the list met with list members. Alternatively, the attendee that generated the list can also manually indicate that he/she has met with a list member. It is noted that other member entities can create lists. For example, an event organizer can create a list of registered attendees. Each attendee's location data can be provided to the exemplary online event system, and an attendee's status can be set according to the location data. For example, an attendee whose location data indicates that the attendee is present at the event can be set to ‘attendee is present’. FIG. 3 can also be implemented in a cloud computing environment. List data can be utilized for various analytical calculations and member entity statistics.

FIG. 4 illustrates an example process 400 for internet-based social-networking application for face-to-face venues, according to some embodiments. In step 402, member entities can create one or more profiles on an online event service. In step 404, member entity profiles can be aggregated and summarized in an attendee list viewable by all member entities of the venue/event via the online event service. In step 406, member entities can flag other attendees they would like to meet at the event. In step 408, online event service can generate a ‘like-to-meet’ list. In step 410, online event service can track of which member entities actually meet members in the like-to-meet list. In step 412, online event service can enable member entities to write notes about the other member entities. In step 414, online event service can suggest other member entities for the member entity to add to like-to-meet list. In step 416, member entities can use the client application of the online event service to check into venue upon arriving and check out via leaving. In step 418, analytics can be collected on the attendee's interactions or behavior at the event. In step 420, dynamic and/or predefined creation of survey(s) can be pushed out to the client applications of attendees, partners, advertisers. In step 422, member data exported by hosts/organizers.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method comprising:
obtaining a member profile of a user for an event service;
aggregating the member entity profile into a set of member profiles;
summarizing the set of member profiles into an attendee list, wherein the attendee list is viewable event via an online event service webpage;
enabling the user to flag another attendee of the attendee list with a client-side application of a mobile device;
tracking the user at an event related to the attendee list;
determining when the user interacted with the other attendee;
receiving a digital notes from the user about the other attendee; and
suggesting a third member entities for the user to flag based on historical user flagging behavior or user profile information.

2. The method of claim 1, wherein the entity profile is obtained with an event server.

3. The method of claim 2, wherein user creates multiple profiles each corresponding to a separate venue.

4. The method of claim 3 further comprising:
notifying the other attendee when the other attendee is flagged by the user.

5. The method of claim 4 further comprising:
matching the user with a representative of an event sponsor.

6. The method of claim 5 further comprising:
enabling the user to check into the event with the client-side application in the mobile device.

7. The method of claim 6 further comprising:
enabling the user to check out of the event with the client-side application in the mobile device.

8. The method of claim 7 further comprising:
implementing an ad-hoc question and answer session between the user and another presenting user during the event.

9. A computer system comprising:
a processor configured to execute instructions;
a memory containing instructions when executed on the processor, causes the processor to perform operations that:
obtain a member profile of a user for an event service;
aggregate the member entity profile into a set of member profiles;
summarize the set of member profiles into an attendee list, wherein the attendee list is viewable event via an online event service webpage;
enable the user to flag another attendee of the attendee list with a client-side application of a mobile device;
track the user at an event related to the attendee list:
determine when the user interacted with the other attendee;
receive a digital notes from the user about the other attendee; and
suggest a third member entities for the user to flag based on historical user flagging behavior or user profile information.

10. The computer system of claim 9, wherein the entity profile is obtained with an event server.

11. The computer system of claim 10, wherein user creates multiple profiles each corresponding to a separate venue.
